(19) United States
(12) Patent Application Publication
(10) Pub. No.: US 2008/0172356 A1
(43) Pub. Date: Jul. 17, 2008

(54) PROGRESSIVE PARAMETRIC QUERY OPTIMIZATION

(75) Inventors: Nicolas Bruno, Redmond, WA (US); Pedro Gustavo Santos Rodrigues Bizarro, Santa Clara (PT)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/623,957

(22) Filed: Jan. 17, 2007

(51) Int. Cl. G06F 7/06

(52) U.S. Cl. 707/2; 707/E17.017

(57) ABSTRACT

A system and method that facilitates and effectuates database query optimization, comprising a progressive optimization component that receives a query and associated parametric values, and based at least in part on the received query, the progressive optimization component determines whether or not the query has been submitted in the past. Where the query has been previously submitted, the progressive optimization component locates an optimal or near-optimal execution plan based on previously persisted and similarly situated and optimized execution plans that can subsequently be used to evaluate the query and its associated parametric values thereby obviating unnecessary and repeated calls to a database optimizer for queries that are similar though not necessarily identical.

### BACKGROUND

Computing and network technologies have transformed many aspects of everyday life. Computers have become household staples rather than luxuries, educational tools and/or entertainment centers, and provide individuals and corporations with tools to manage and forecast finances, control operations such as heating, cooling, lighting and security, and store records and images in a permanent and reliable medium. Networking technologies like the Internet provide individuals virtually unlimited access to remote systems, information and associated applications.

As computing and network technologies have evolved and have become more robust, secure and reliable, more consumers, wholesalers, retailers, entrepreneurs, educational institutions and the like are shifting paradigms and are employing the Internet to perform business rather traditional means. For example, today consumers can access their bank accounts on-line (e.g., via the Internet) and can perform an ever growing number of banking transactions such as balance inquiries, fund transfers, bill payments, and the like.

Typically, an on-line session can include individuals interfacing with client applications (e.g., web services) to interact with a database server that stores information in a database accessible to client applications. For instance, a stock market web site can provide users with tools to retrieve stock quotes and purchase stock. Users can enter stock symbols and request stock quotes by performing mouse clicks to activate a query. Client applications can then query databases containing stock information and return appropriate stock quotes. Users, based on returned stock quote information, can thereafter purchase or sell stocks by supplying suitable information, wherein submitting buy or sell orders initiate database queries to return current pricing information and order status.

Typically, when database queries are issued to database servers each query submitted can be compiled into one or more execution plans that can be subsequently executed by the database server to satisfy the submitted query. Some submitted queries take the form of parametric queries (e.g., the queries have associated open parameters that an individual fills out). As a simplistic example, a submitted query can take the form: “Give me the account number of X”, where X is a parametric variable. Prior to execution of the foregoing query by the database server, the parametric variable X can be replaced with a name (e.g., Fred Smith, Jane Doe, etc.), resulting in a query of the form: “Give me the account number of Joe Blow” that can subsequently be executed by the database server.

It has been observed however with parametric queries that, based on the actual parameters involved in the query, optimization by the database optimizer of the parametric query can yield differing optimized execution plans. In other words, for example, optimization of the completed parametric query: “Give me the account number of Joe Blow” can yield a totally different optimized execution plan than the parametric query: “Give me the account number of Jane Doe”, yet from the perspective of the database optimizer both generated execution plans are optimal with respect to the parametric variables employed (i.e., Joe Blow and Jane Doe) in the submitted query.

Optimization of database queries is generally an expensive proposition both in time and processor cycles needed to generate optimal execution plans. Typically, database servers attempt to obviate, or at the very least minimize, the number and frequency of calls made to the database optimizer. To date, in order to overcome the expenses associated with repeatedly optimizing parametric database queries, the database optimizer has heretofore gathered together all parametric queries regardless of individuated parametric values and has assigned the same plan to each parametric query—a one size fits all approach. Under this approach the first submitted and optimized parametric query holds sway over all subsequently submitted parametric queries even though subsequently submitted parametric values may ideally warrant that the parametric query and its accompanying parametric values be re-evaluated (or evaluated afresh) to obtain the most (or nearly) optimal execution plan based at least on the submitted parametric values. Nevertheless, the one size fits all approach, while providing sub-optimal (or severely sub-optimal) execution plans for the majority of parametric queries submitted for execution by the database server, however does save time in that the optimizer does not need to re-compile each and every parametric query to generate an associated optimized execution plan.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

Many commercial applications rely on pre-compiled parameterized procedures to interact with databases. However, executing procedures with sets of parameters different from those used at compilation can arbitrarily be sub-optimal. Parametric Query Optimization (PQO) modalities attempt to solve this sub-optimality problem by exhaustively determining optimal plans in each point of parameter space at compile time. It has been found however, that Parametric Query Optimization (PQO) is typically not cost-effective where queries are executed infrequently or where the Parametric Query Optimization (PQO) modalities are executed with values only within a subset of the parameter space. To overcome these limitations, the claimed subject matter can progressively explore a parameter space and build parametric plans during several executions of the same (or similar) queries, such that as parameter plans are populated the claimed subject matter can typically bypass the optimizer but can still execute optimal or near optimal plans.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine implemented progressive parametric query optimization system in accordance with the claimed subject matter.

FIG. 2 provides a more detailed block diagram of a progressive parametric query optimization component in accordance with one aspect of the claimed subject matter.

FIG. 3 is a more detailed depiction of a retrieval component in accordance with one aspect of the subject matter as claimed.

FIG. 4 provides a detailed illustration of retrieval component in accordance with yet a further aspect of the claimed subject matter.

FIG. 5 depicts a graph utilized to illustrate one aspect of the subject matter as claimed.

FIG. 6 provides a graphical representation of value-based parameter space in accordance with illustrative aspects of the disclosed subject matter.

FIG. 7 is a graphical representation of selectivity-based parameter space in accordance with yet further illustrative aspects of the claimed subject matter.

FIG. 8 depicts a graph employed to further illustrate aspects of the claimed subject matter.

FIG. 9 provides a graphical representation employed to further elucidate an illustrative aspect of the claimed subject matter.

FIG. 10 illustrates a flow diagram of a methodology that facilitates and effectuates progressive parametric query optimization in accordance with the claimed subject matter

FIG. 11 illustrates a block diagram of a computer operable to execute the disclosed progressive parametric query optimization architecture.

FIG. 12 illustrates a schematic block diagram of an exemplary computing environment for processing the progressive parametric query optimization architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

Currently there are a number of alternatives to deal with optimization and execution of parameterized queries, such as Optimize-Always, Optimize-Once, and Parametric Query Optimization (PQO). Optimize-Always calls the optimizer and generates a new execution plan each and every time a query is invoked. The disadvantages of this approach are: a call to the optimizer is made for each execution which can constitute (especially for simple queries) a significant part of the total execution time; and Optimize-Always can limit the number of concurrent queries in the system as the optimization process itself can consume an inordinate amount of memory.

Optimize-Once optimizes the query just once with a set of parameter values and reuses the resulting physical plan for other sets of parameters. While the Optimize-Once approach returns a single plan that can be utilized for all points in a parameter space, the chosen plan can nevertheless be arbitrarily sub-optimal in all points of the parameter space other than the point for which the query was optimized.

Parametric Query Optimization (PQO) determines at optimization time sets of plans such that, for each point in a parameter space, there is at least one optimal plan. Additionally, Parametric Query Optimization (PQO) can ascertain regions of optimality for each computed plan. Typically, Parametric Query Optimization (PQO) assumes that the cost formulas of physical plans are linear or piece-wise linear with respect to cost parameters or that the regions of optimality are connected and/or convex. In reality, however, cost functions of physical plans are not necessarily linear or piece-wise linear and the regions are not necessarily connected and/or convex. In addition, Parametric Query Optimization (PQO) generally has a much higher costs than optimizing a query a single time (e.g., Parametric Query Optimization (PQO) may require multiple invocations of the optimizer with different parameters). Consequently, from a database perspective, when a procedure execution request arrives, it may not be clear whether Parametric Query Optimization (PQO) should be employed or not: it may not be cost-effective where the procedure is not executed sufficiently frequently or if the procedure is executed with values only within a sub-space of the entire parameter space.

The claimed subject matter relates to systems and methods that employ a technique known as Progressive Parametric Query Optimization (PPQO) that overcomes the aforementioned shortcomings of PQO. Progressive Parametric Query Optimization (PPQO), as the name suggests, progressively solves or approximates solutions to a PQO problem (discussed infra) as successive query execution calls, with potentially different input parameters being submitted. Thus, given a query and associated parameter values, a call to an optimizer returns an optimal physical execution plan and the estimated cost of executing the optimal physical plan.

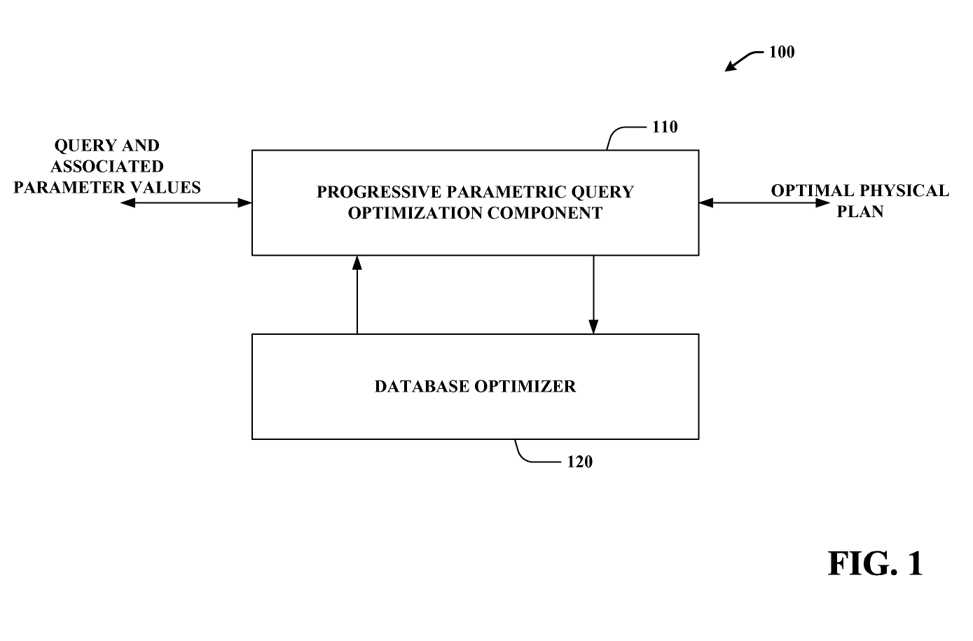

FIG. 1 illustrates a progressive parametric query optimization system 100 resident in, and/or associated with, a database server (not shown), that includes a progressive parametric optimization component 110 that intercepts inputs to and outputs from an optimizer 120 and that registers which physical plans (or parametric plans) that are estimated to be optimal and for which points in a parameter space in a structure called a parametric plan. In order to facilitate and effectuate its aims, progressive parametric optimization component 110 receives queries and accompanying parameter values and determines whether or not identical and/or similar queries and associated parameter values have previously been submitted and registered. Where the progressive parametric optimization component 110 ascertains that identical and/or similar queries and associated parameter values have been submitted and registered in the past the progressive parametric optimization component 110 retrieves an optimal or nearly optimal physical plans from a data store associated with progressive parametric optimization component 110 and outputs the one or more optimal or nearly optimal physical plans for subsequent utilization by a database server. Conversely, where progressive parametric optimization component 110 determines that similar queries and associated parameter values have not been submitted to, and/or have not been registered with, the database server in the past, progressive parametric optimization component 110 directs the received query and associated parameters to database optimizer 120. Database optimizer 120 upon receipt of the query and associated parameters determines the most optimal or nearly optimal execution plan based at least in part on the submitted query and its accompanying parameters. Once database optimizer 120 has analyzed the query and associated parameters and determined the most optimal or nearly optimal physical execution plan given the submitted query and the associated parameters, database optimizer 120 directs the resultant optimal or nearly optimal execution plan to progressive parametric optimization component 110 which persists the resultant execution plan in an associated data store for future use, and thereafter outputs the optimal or nearly optimal physical execution plan for subsequent utilization by a database server. Eventually, as more and more optimal and/or closely optimal physical execution plans (parametric plans) are persisted and populate the data store associated with progressive parametric optimization component 110, progressive parametric optimization component 110 can employ these persisted parametric plans to bypass database optimizer 120.

It should be noted as an observation rather than a limitation that due to the size of the parameter space, parametric plans typically should not be implemented simply as exact lookup caches of plans as there can be too many cache misses. Additionally, as a further observation rather than a limitation, due to the non-linear and discontinuous nature of cost functions, parametric plans generally should avoid being implemented as nearest neighbor lookup structures as there will be no guarantee that the optimal plan of the nearest neighbor is optimal or close to optimal for the parameter point under consideration.

While FIG. 1 is a block diagram illustrating components for the system 100, it is to be appreciated that the system 100, the progressive parametric query optimization component 110 and the database optimizer 120 can be implemented as one or more computer components, as that term is defined herein. Thus, it is to be appreciated that computer executable components operable to implement the system 100, the progressive parametric query optimization component 110 and the database optimizer 120 can be stored on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention.

As alluded to supra, the parametric query optimization problem can be enunciated as follows. If it is assumed that a (parametric) query Q is a text representation of a relation query with placeholders for m values vpt=(v₁, . . . , vₘ). Vector vpt is called a ValuePoint. Further assume that plan p is some execution plan that evaluates query Q for vpt. The cost function of p, p(cpt), is a function of n cost parameters, cpt=(s₁, . . . , sₙ). Vector cpt is called a CostPoint and each sᵢ is a cost parameter with an ordered domain. Additionally, assume that for every legal value of the parameters, there is some plan that is optimal. Given a parametric query Q, the maximum parametric set of plans (MPSP) is the set of plans, each of which is optimal for some point in the n-dimensional cost-based parameter space. MPSP={p|p is optimal for some point in the cost-based parameter space}. Further let the region of optimality for plan p be denoted as r(p), r(p)={(t₁, . . . , tₙ)|p being optimal at (c₁=t₁, . . . , Cₙ=tₙ)}, and a parametric optimal set of plans (POSP) is a minimal subset of MPSP that includes at least one optimal plan for each point in the parameter space. Then the parametric query optimization (PQO) problem is to find a POSP and the region of optimality for each plan in POSP.

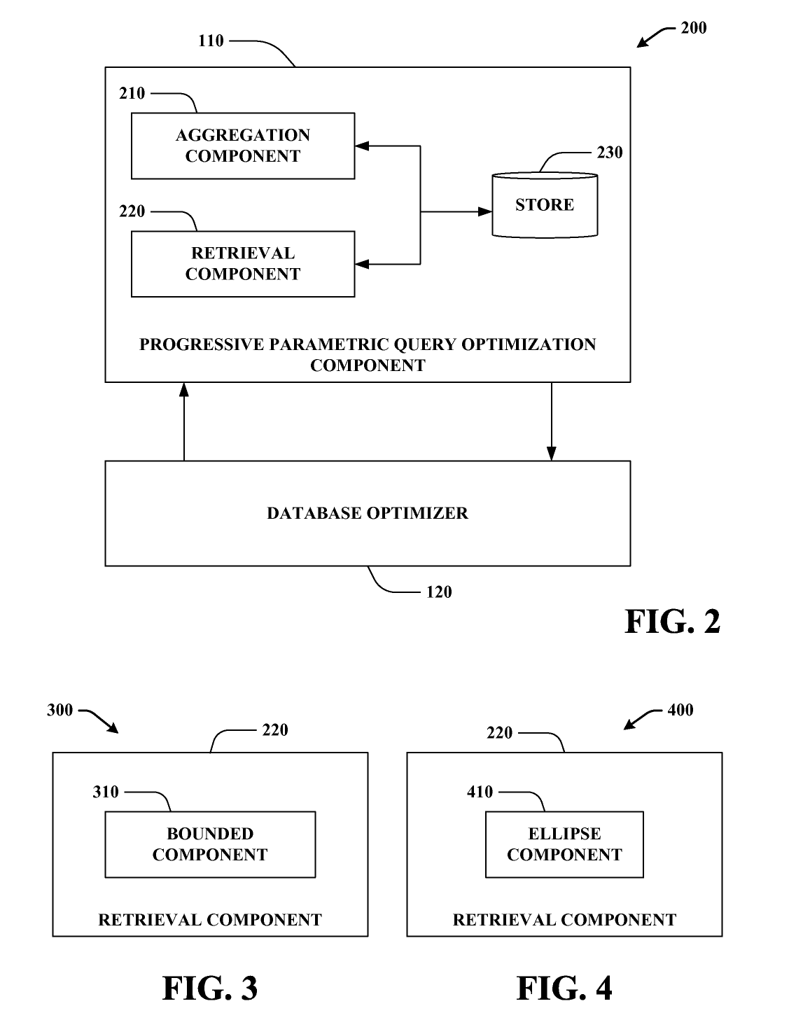

FIG. 2 provides a more detailed depiction of progressive parametric query optimization component 110 that can include an aggregation component 210 that registers plans deemed optimal by database optimizer 120 in an associated store 230, and a retrieval component 220 that either searches the associated store 230 and returns a plan that can be beneficially employed to execute a particular submitted query together with the associated the cost values should the returned plan be executed, or returns null. The progressive parametric query optimization component 110 effectively employs the following function:

function processQuery (Query Q, ValuePoint vpt, Parametric_Plan pp) {

| | |
|---|---|
| CostPoint cpt ← φ(Q, vpt); | //ValuePoint to CostPoint |

| | |
|---|---|
| Plan p ← pp.getPlan(Q, cpt); | //what plan to use? |
| if (p == NULL) { | |

| | |
|---|---|
| Cost cost; | //estimated cost is output parameter in call below |

| | |
|---|---|
| p ← optimize(Q, vpt, cost); | //calls optimizer |

| | |
|---|---|
| pp.addPlan(Q, cpt, p, cost); | //stores info in Parametric_Plan |
| }; | |
| execute(p); | |
| }; | |

Function φ causes progressive parametric query optimization component 110 to consult input query Q, and transform ValuePoint vpt into CostPoint cpt. The operations, addPlan(Q, cpt, p, cost) and getPlan(Q, cpt) are undertaken by aggregation component 210 and retrieval component 220 respectively. It should be noted by way of observation rather than limitation that function φ is optimizer specific, the justification for utilization of which is set forth infra.

Thus, the foregoing processQuery function that can be utilized by progressive parametric query optimization component 110 effectuates a transformation of ValuePoint vpt into CostPoint cpt, thereafter a determination is made as to which plan should be used. In order to determine the appropriate plan to employ for a particular query Q, progressive parametric query optimization component 110 can utilize retrieval component 220 by supplying query Q and the previously ascertained CostPoint cpt. Where the result from retrieval component 220 is null (e.g., there currently are no stored plans in store 230 with associated parametric values that have been deemed optimal) progressive parametric query optimization component 110 supplies query Q, ValuePoint vpt, to database optimizer 120. Database optimizer 120 subsequently returns an optimized execution plan p and an associated estimated cost, cost, for the execution of the returned execution plan. The optimized execution plan p, query Q, CostPoint cpt, and returned estimated cost are then provided to aggregation component 210 which stores this information in associated store 230 for future reference by retrieval component 220.

It should be noted that progressive parametric query optimization component 110 in addition to effectuating progressive parametric query optimization, can also implement Optimize-Always and Optimize-Once strategies. For example, Optimize-Always can be implemented by ensuring that aggregation component 210 never adds any plans to store 230 with the consequential result that retrieval component 230 can never locate any optimal plans in store 230 and thus retrieval component 230 always returns null, forcing an optimization call to database optimizer 120 for every query Q. Similarly, Optimize-Once can be implemented by ensuring that aggregation component 210 saves in store 230 the initial plan that it is first supplied with by database optimizer 120, after which aggregation component 210 can be placed in a dormant and/or another non-functional state. Thus, since store 230 only has a single optimized plan saved therein, retrieval component 230 always returns the single optimized plan persisted in store 230 for all calls.

In order for Progressive Parametric Query Optimization (PPQO) to be effective and efficacious, progressive parametric query optimization component 110 needs wherever possible to avoid as many optimization calls to database optimizer 120. In order for this to occur progressive parametric query optimization component 110 needs to be able to recognize, and be willing to, supply sub-optimal plans provided that these sub-optimal plans have costs close to the cost that would be incurred had an optimal plan been available and selected. Thus, progressive parametric query optimization component 110 needs to be cognizant of the following pertinent inference requirement.

After aggregation component 210 has been called a number of times it can be assumed/inferred that store 230 has been populated with sufficient optimal execution plans such that when retrieval component 220 accesses store 230 that it will be able to locate an optimal and/or near-optimal plan p for query Q and parameter CostPoint cpt, even where the aggregation component 210 is never employed.

Consequentially, given a sequence of execution requests of the same or similar queries with potentially different input parameters, progressive parametric query optimization component 110 can, for example, have two conflicting goals: (i) minimize the number of optimization calls to database optimizer 120; and (ii) execute plans with costs as close to the cost of an optimal plan as possible.

It should be noted as an observation rather than as a limitation, that a cache implementation of progressive parametric query optimization component 110—storing (query Q, CostPoint cpt) pairs as a lookup key and (optimal plan p, estimate cost cost) as the inserted value—typically cannot fulfill the above inference requirement because such an implementation returns hits only for previously inserted (query Q, CostPoint cpt) pairs. Thus, in order to overcome at least this perceived impediment progressive parametric query optimizer component 110, and in particular retrieval component 220 can be implemented in one of two ways. Each implementation of retrieval component 220 gives priority to one of the above two goals.

Justification for the necessity and utilization of transformative function φ and its implementation is as follows. Value parameters can refer to input parameters of the parametric SQL query to execute. Cost parameters can be input parameters in formulas employed by the optimizer to estimate the cost of a query plan. Cost parameters are estimated during query optimization based at least in part on value parameters and in part from information in the database catalog (e.g. store 230). (Physical characteristics that can affect the cost of query plans but do not depend on the query parameters (e.g. the average size of tuples in a table or the cost of a random I/O—are considered physical constants, not cost parameters).

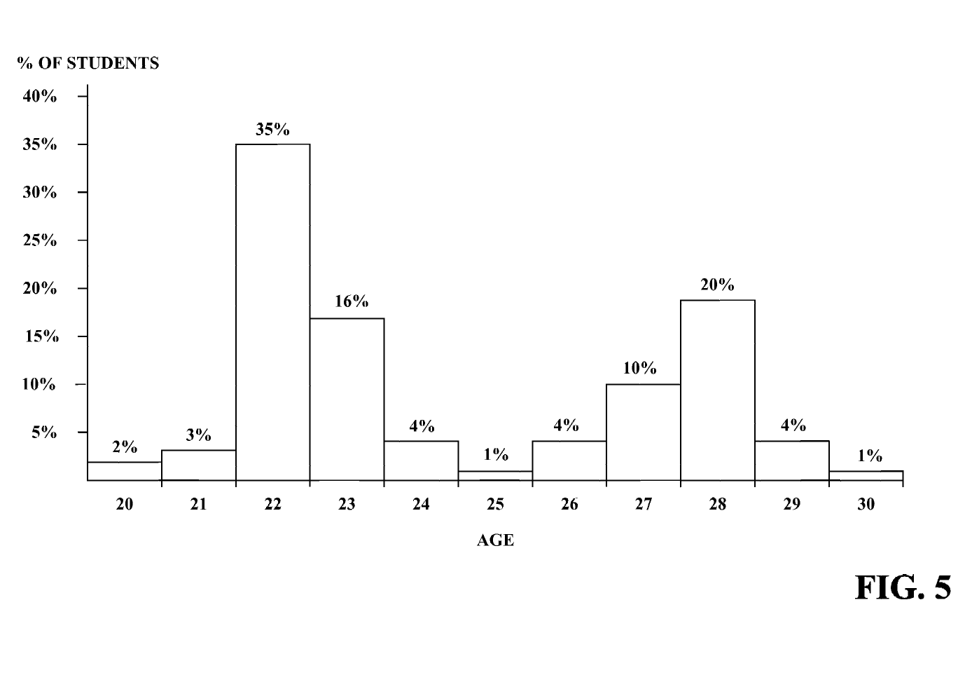

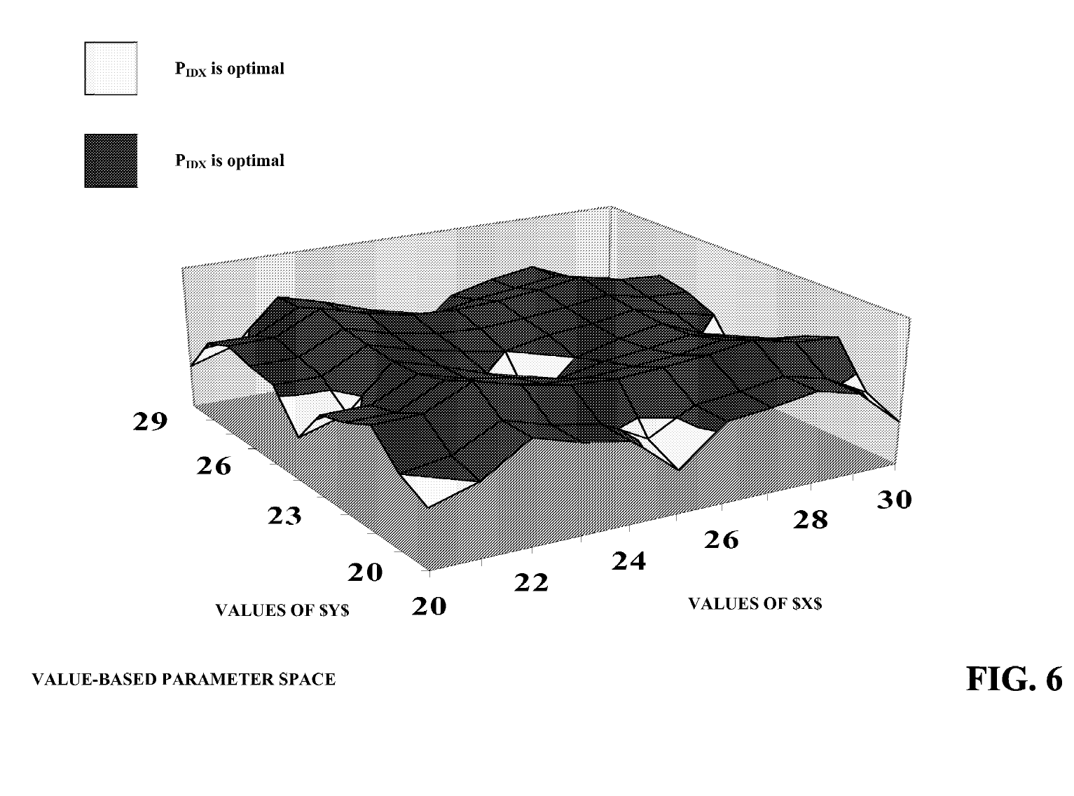

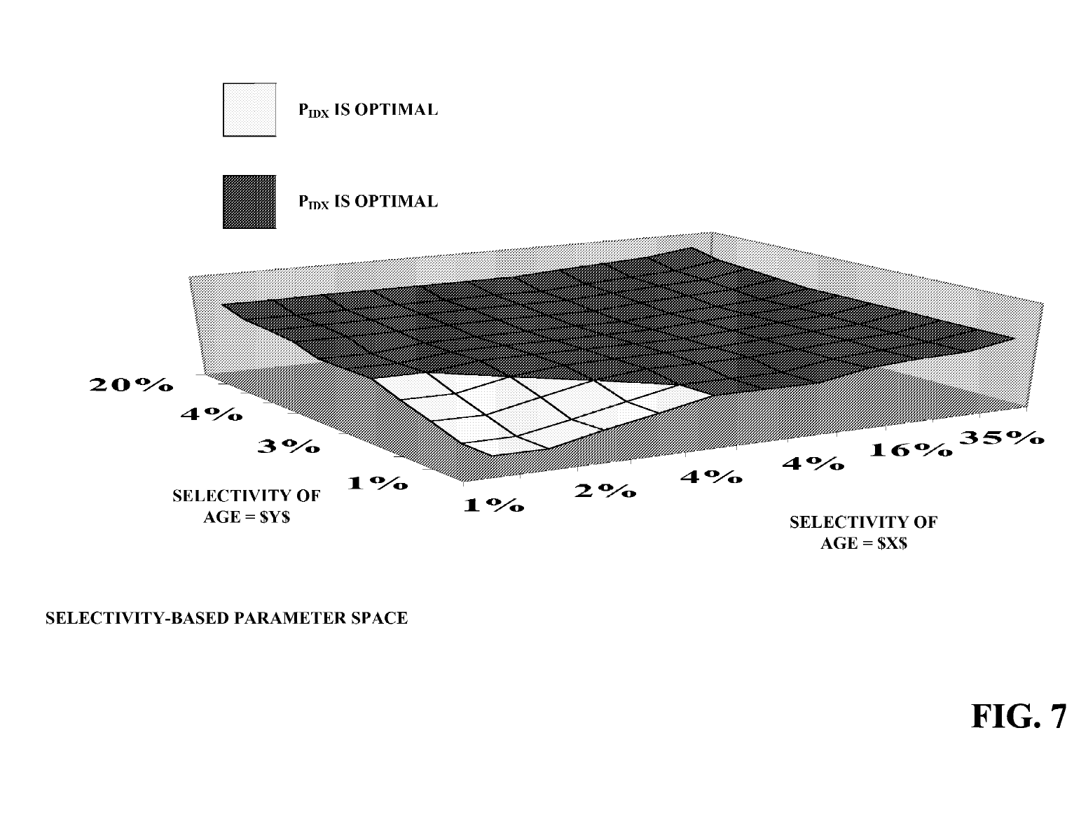

An important type of cost parameter used during optimization can be the estimated number of tuples in (intermediate) relations processed by the query plan: most query plans have cost formulas that are monotonic with the number of tuples processed by the query. On the other hand, there need not be an obvious relationship between the value parameters and the cost of the query plans. Thus, it becomes much easier to characterize the regions of optimality using a cost-based parameter space rather than using a value-based parameter space. In the following example, and in what follows, it is assumed that a cost-based parameter space whose dimensions are (predicate or join) selectivities. (The estimated number of tuples of each relation processed by a query is typically derived from selectivities of sub-expressions computed during query optimization). Thus, for example, where a table FRESHMEN(NAME, AGE) describes 1^{st}-year graduate students. The age distribution of students is illustrated in FIG. 5. Consider different queries of the form SELECT*FROM FRESHMEN WHERE AGE=$X$ OR AGE=$Y$. Assume that the optimal plan for queries that retrieve less than 5% of FRESHMEN tuples is P_{IDX}, a plan using an index on column AGE. For all other queries, the optimal plan is P_{FS}, a full-table scan on FRESHMEN. The parameters of this query can be represented as the absolute values used for parameters $X$ and $Y$ or as the selectivities of predicate AGE=$X$ and predicate AGE=$Y$. Accordingly, the costs of physical P_{IDX} and P_{FS} can be represented in value-based parameter spaces or in selectivity-based parameter spaces as seen in FIGS. 6 and 7.

Thus, in one aspect of the claimed subject matter function φ takes query Q and its SQL parameters, vpt, and returns cpt as a vector of selectivities. Computing the selectivities in cpt corresponds to selectivity estimation, a sub-task of query optimization. Other components of query optimization (e.g., plan enumeration, rule transformation, plan costing, and plan pruning) typically need not be executed by function φ. It should be noted by way of observation rather than limitation that the arity of the value-based parameter space and of the selectivity-based parameter space are not necessarily the same. For range predicates and equality predicates, computing selectivity values from actual values—essentially the task of function φ—can be performed efficiently by lookups on cumulative histograms.

FIG. 3 provides a more detailed depiction of retrieval component 220 wherein in one aspect of the claimed subject matter retrieval component 220 can include a bounded component 310 that guarantees the quality of plans returned by retrieval component 220, thus giving precedence to executing plans with costs as close to the cost of an optimal plan as possible (e.g., either the returned plan p is null—meaning that an optimization call to database optimizer 120 cannot be avoided—or plan p has a cost guaranteed to be within a bound (e.g. specified by the user) of the cost of the optimal plan.

Under this aspect of the claimed subject matter aggregation component 210 (see FIG. 2) when supplied with query Q, CostPoint cpt, plan p, and estimated cost cost associates with each parametric query Q a list, T_{Q}, of triples (cpt, p, cost) ordered by cost, where p is an optimal plan at CostPoint cpt with an estimated execution cost of cost.

In order to comprehend the import of the functionality of bounded component 310 the following preliminaries and definitions are required to be understood and are presented for the purposes of elucidation rather than limitation. Relationship equal (≡): Given cpt₁=(c_{1,1}, . . . , c_{1,n}) and cpt₂=(c_{2,1}, . . . , c_{2,n}), cpt₁≡cpt₂ if and only if c_{1,i}=c_{2,i}, ∀i. Relationships below ( [symbol] ) and above ( [symbol] ): Given cpt₁=(c_{1,1}, . . . , c_{1,n}) and cpt₂=(c_{2,1}, . . . , c_{2,n}), cpt₁ [symbol] cpt₂ (cpt₁ [symbol] cpt₂) if and only if c_{1,i}≦c_{2,i} (c_{1,i}≧c_{2,i}), ∀i and ∃i, c_{1,i}≠c_{2,i}. Transitive property of [symbol] and [symbol] : From the definitions it follows that if cpt₁ [symbol] cpt₂ (cpt₁ [symbol] cpt₂) and cpt₂ [symbol] cpt₃ (cpt₂ [symbol] cpt₃) then cpt₁ [symbol] cpt₃ (cpt₁ [symbol] cpt₃). Monotonic Assumption (MA): Given plan p and CostPoints cpt₁ and cpt₂, if cpt₁ [symbol] cpt₂ then p(cpt₁)≦p(cpt₂). It should be noted at this juncture that cost parameters utilized herein are selectivities. Since higher selectivities imply more tuples to process, the monotonic assumption follows the intuition that plans that process more tuples likely cost more than plans that process less tuples. Although not true for all queries (e.g., queries using SQL clause NOT EXISTS may have non-monotonic costs) plans with non-monotonic costs are less common than plans with costs monotonic with the number of processed tuples. Opt(cpt): This is the cost of an optimal plan at cpt.

Consequently, it can be theorized (referred to hereinafter as Theorem 1) that if ∃tᵢ=(cptᵢ, planᵢ, costᵢ), ∃tⱼ=(cptⱼ, planⱼ, costⱼ), such that plan planᵢ (planⱼ) is an optimal plan at cptᵢ (cptⱼ) with cost costᵢ (costⱼ), cptᵢ [symbol] cpt [symbol] cptⱼ and costⱼε[costᵢ, costᵢ*M+A], then planⱼ(cpt)ε[Opt(cpt), Opt(cpt)*M+A] where M is a multiplicative factor and A is an additive factor.

Thus, should bounded component 310 be supplied with a query Q and a CostPoint cpt, bounded component 310 is guaranteed to either return null or to return a plan p with an estimated cost as close to the estimated optimal cost as desired. Specifically, for any constants M≧1 and A≧0, bounded component 310 guarantees that one of the following holds true: (i) the returned plan p is null or (ii) p(cpt)ε [Opt(cpt), Opt(cpt)*M+A]. Therefore, given two triples t₁=(cpt₁, p₁, cost₁) and t₂=(cpt₂, p₂, cost₂), where cpt₁ and cpt₂ are CostPoints, cost₁ (cost₂) is the positive cost of optimal plan p₁ (p₂) at cpt₁ (cpt₂), and any constants M≧1 and A≧0. If cpt₁ [symbol] cpt [symbol] cpt₂ and cost₂ε[cost₁, cost₁*M+A] then it can be stated: (t₁, t₂) bounds cpt, and plan p₂ is bounded at cpt.

Thus, by Theorem 1, if p₂ is bounded at cpt then p₂(cpt)ε[Opt(cpt), Opt(cpt)*M+A]. Given M≧1, A≧0, query Q and CostPoint cpt, bounded component 310 searches for a (t₁, t₂) pair that bounds cpt and returns p₂, a bounded plan at cpt, fulfilling point (ii) above. If no (t₁, t₂) bounding pair for cpt exists, bounded component 310 returns null, fulfilling point (i) above.

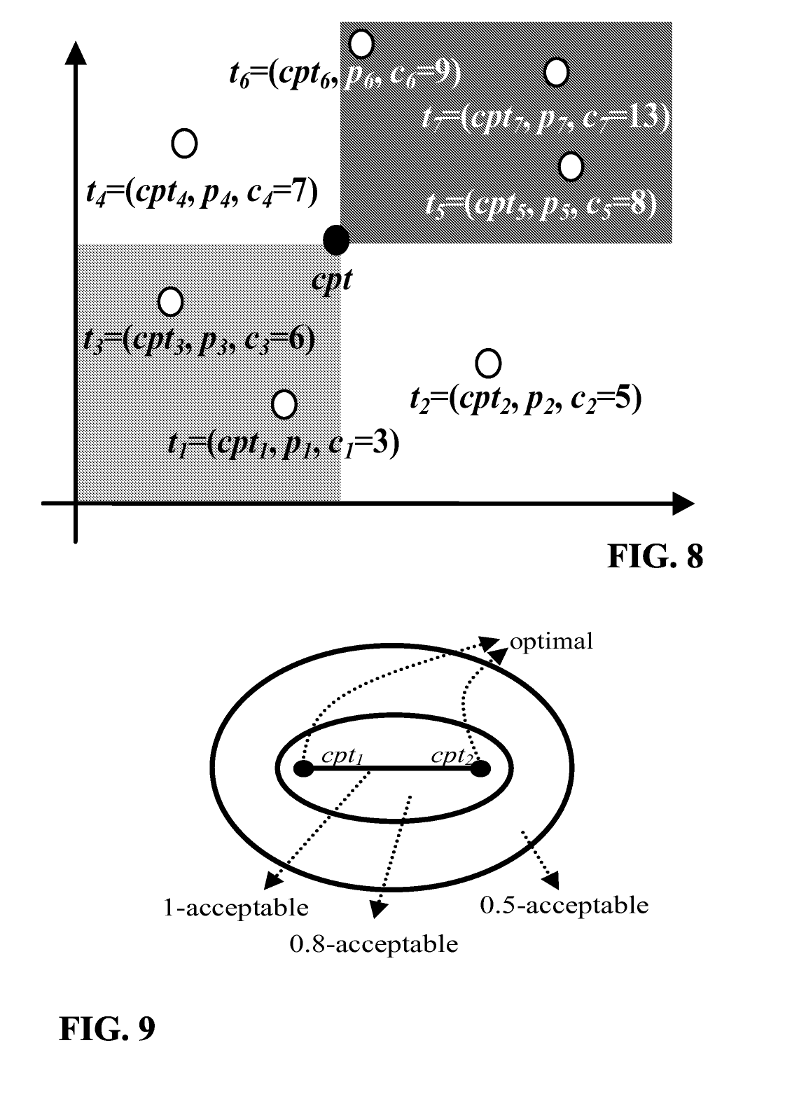

The foregoing can be illustrated as follows and depicted in FIG. 8. If it is assumed for some query Q that aggregation component 110 has added to store 230 the triplets shown below, (e.g., T_{Q}=(t₁, t₂, t₃, t₄, t₅, t₆, t₇)). Then given, cpt (e.g., the black dot in FIG. 8) in the cost-based parameter space, where M=1.5, and A=0, what plan will bounded component 310 return when supplied with a query Q and CostPoint cpt? Since there are six pairs (cptᵢ, cptⱼ) such that cptᵢ [symbol] cpt [symbol] cptⱼ: (cpt₁, cpt₅), (cpt₁, cpt₆), (cpt₁, cpt₇), (cpt₃, cpt₅), (cpt₃, cpt₆), and (cpt₃, cpt₇). From those pairs, only two triples bound cpt: pair (t₃, t₅), because c₅ ε [c₃, c₃*1.5+0] [symbol] 8 ε [6, 9], and pair (t₃, t₆), because c₆ε[c₃, c₃*1.5+0] [symbol] 9 ε [6, 9]. Thus, both plan p₅ and plan p₆ are bounded at cpt and either of them can be returned by bounded component 310.

Now if one considers T_{Q}, the list containing k triples (cptᵢ, pᵢ, costᵢ) persisted in store 230 by aggregation component 210. A naïve implementation of bounded component 310 could enumerate all pairs of tuples (tᵢ, tⱼ), tᵢεT_{Q}, tⱼεT_{Q}, tᵢ≠tⱼ and test if any pair bounds cpt, and where a pair (tᵢ, tⱼ) bounds cpt, then plan pⱼ can be returned. A more sophisticated implementation of bounded component 310 in contrast could divide divides T_{Q} into two lists. Then, given the properties of the two lists (described below), it is possible to trivially select a single triple, t₁, from one list and a single triple, t₂, from the other list such that only pair (t₁, t₂) needs to be checked.

At this juncture it might be constructive to further define the [symbol] (below) operator and [symbol] (above) operator as utilized and employed by one aspect of the claimed subject matter. To illustrate this consider a list, T_{Q}, containing k triples (cptᵢ, pᵢ, costᵢ) ordered by costᵢ, with i=0 . . . k−1, where cptᵢ is a CostPoint and costᵢ represents the cost of executing the optimal plan pᵢ at cptᵢ. Given cpt, another CostPoint, T_{Q} [symbol] _{cpt} is the list of triples (cptᵢ, pᵢ, costᵢ) from T_{Q}, ordered by costᵢ, such that cptᵢ [symbol] cpt. Similarly, T_{Q} [symbol] _{cpt} is the list of triples (cptᵢ, pᵢ, costᵢ) from T_{Q} ordered by costᵢ, such that cptᵢ [symbol] cpt. T_{Q} [symbol] _{cpt} and T_{Q} [symbol] _{cpt} are trivially constructed from a single pass over T_{Q}. Note that, by definition, cpt_{b} [symbol] cpt [symbol] cptₐ, ∀cpt_{b}:t_{b}=(cpt_{b}, p_{b}, cost_{b}) ε T_{Q} [symbol] _{cpt}, ∀cptₐ:tₐ=(cptₐ, pₐ, cost_{ba})εT_{Q} [symbol] _{cpt}. Thus, for example, if T_{Q}=(t₁, t₂, t₃, t₄, t₅, t₆,), where the tᵢ are the triples shown in the graph above, then T_{Q} [symbol] ₒₚₜ=(t₁, t₃) (the triples represented in the light gray area) and T_{Q} [symbol] _{cpt}=(t₅, t₆, t₇) (the triples represented in the dark gray area).

It can thus be theorized (hereinafter referred to as Theorem 2), if ∃cpt_{b}:t_{b}=(cpt_{b}, p_{b}, cost_{b}), t_{b}εT [symbol] _{cpt}, ∃cptₐ:tₐ=(cptₐ, pₐ, costₐ), tₐεT [symbol] _{cpt}, and costₐε[cost_{b}, cost_{b}*M+A], then cost_{first}ε[costₗₐₛₜ, costₗₐₛₜ*M+A], where cost_{first} is the cost of the first triple in T [symbol] _{cpt} and costₗₐₛₜ is the cost of the last triple in T [symbol] _{cpt}. Consequently, if there is a possible solution to be located by bounded component 310, then by Theorem 2 one need only check if cost_{first}ε[costₗₐₛₜ, costₗₐₛₜ*M+A], where c_{first} is the cost of the first triple in T_{Q} [symbol] _{cpt} and cₗₐₛₜ is the cost of the last triple in T_{Q} [symbol] _{cpt}. If cost_{first}ε[costₗₐₛₜ, costₗₐₛₜ*M+A], then p_{first}, the plan in the first triple of T_{Q} [symbol] _{cpt}, is returned.

In view of the foregoing theoretical discussion the bounded component 310 included in retrieval component 220 can, in one aspect, be implemented to employ the following algorithm.

function getPlan (Query Q, CostPoint cpt) {

| | |
|---|---|
| List T_{Q} ←getList(Q); | //gets list of triples for Q |
| if (T_{Q} ==null) {return null;} | |
| Triple last=null; | //last triple of T_{Q} [symbol] cpt |

| | |
|---|---|
| for Triple t in T_{Q} { | //in cost order |
| if (t.cpt ≡ cpt) {return t.p;} | //exact match? |

| | |
|---|---|
| if (t.cpt [symbol] cpt) {last = t;} | //keep track of last triple of T_{Q} [symbol] cp |

| | |
|---|---|
| if (t.cpt [symbol] cpt) { | //first triple of T_{Q} [symbol] cpt |
| if (last == null) {return null;} | |
| if (t.c∈[last.c, last.c*M+A]) {return t.p;} | |
| }}} | |

While bounded component 310 provides strong guarantees on the cost of plans returned, there typically is a low hit rate for small values of M and A or before T_{Q} has been populated.

FIG. 4 provides a more detailed depiction of retrieval component 220 wherein in one aspect of the claimed subject matter retrieval component 220 can include an ellipse component 410 that minimizes the number of calls made to database optimizer component 120 and that ameliorates the low hit rate that can occur with bounded component 310 when the values of M and A are small and/or before T_{Q} has been sufficiently populated. However, in order to achieve higher hit rates ellipse component 410 drops the guarantee of returning plans with near-optimal costs, as was the case with bounded component 310. Instead ellipse component 410 returns Δ-acceptable plans that can be defined as follows. For Δε[0, 1], if plan p is optimal at points cpt₁ and cpt₂ in the cost-based parameter space, then plan p is Δ-acceptable at point cpt in the cost-based parameter space if and only if distance(cpt₁, cpt₂)/(distance(cpt, cpt₁)+distance(cpt, cpt₂))≧Δ, where the function distance returns the Euclidian distance between two points in an n-dimensional space.

Consequently, if p is optimal at cpt₁ and cpt₂, then p is 1-acceptable only on points between cpt₁ and cpt₂ and p is 0-acceptable at all points. Note that in a 2-dimentional space, the area where p is Δ-acceptable is equivalent to the definition of an ellipse; if p is optimal for cpt₁ and cpt₂, then p is Δ-acceptable at cpt if cpt is on or inside an ellipse of foci cpt₁ and cpt₂ such that the distance between the foci, distance(cpt₁, cpt₂), over the sum of the distances between cpt and the foci, distance(cpt, cpt₁)+distance(cpt, cpt₂), is Δ. For example, the depiction provided in FIG. 9 shows the areas where p is 0.5-acceptable, 0.8-acceptable, and 1-acceptable if p is optimal at cpt₁ and cpt₂. Thus, for each query Q and for each plan p that is optimal in some point of the parameter space, the aggregation component 210 utilized in conjunction with ellipse component 410 can maintain in store 230 a list of (cpt, cost) pairs where p is optimal for Q.

Accordingly, in view of the foregoing ellipse component 410 that can be included in retrieval component 220 can be implemented utilizing the following algorithm,

function getPlan (Query Q, CostPoint cpt) {

| | |
|---|---|
| PlanList P ←getPlanList(Q); | //gets optimal plans |

| | |
|---|---|
| if (P ==null) {return null;} | //tests for empty list |
| for Plan plan in P { | |

| | |
|---|---|
| PointList L←getPointList(Q, plan); | //gets list of points |

| | |
|---|---|
| for PointPair (cpt₁, cpt₂) in L { | // enumerates point pairs |

if (dist(cpt1, cpt2) / (dist(cpt, cpt1) + dist(cpt, cpt2))≧Δ) {

| | |
|---|---|
| return plan; | //found an Δ-acceptable plan |
| }}} | |
| return null; | |
| } | |

wherein the algorithm consists effectively of the ellipse component 410 performing the following acts: for each optimal plan plan, iterating over pairs of points where plan is optimal for query Q. For each pair of points (cpt₁, cpt₂), determine if plan is Δ-acceptable at the given point cpt. If it is, return plan, otherwise continue trying other points and other plans. If all pairs of points of all plans for Q are exhausted without an Δ-acceptable plan being found, return null.

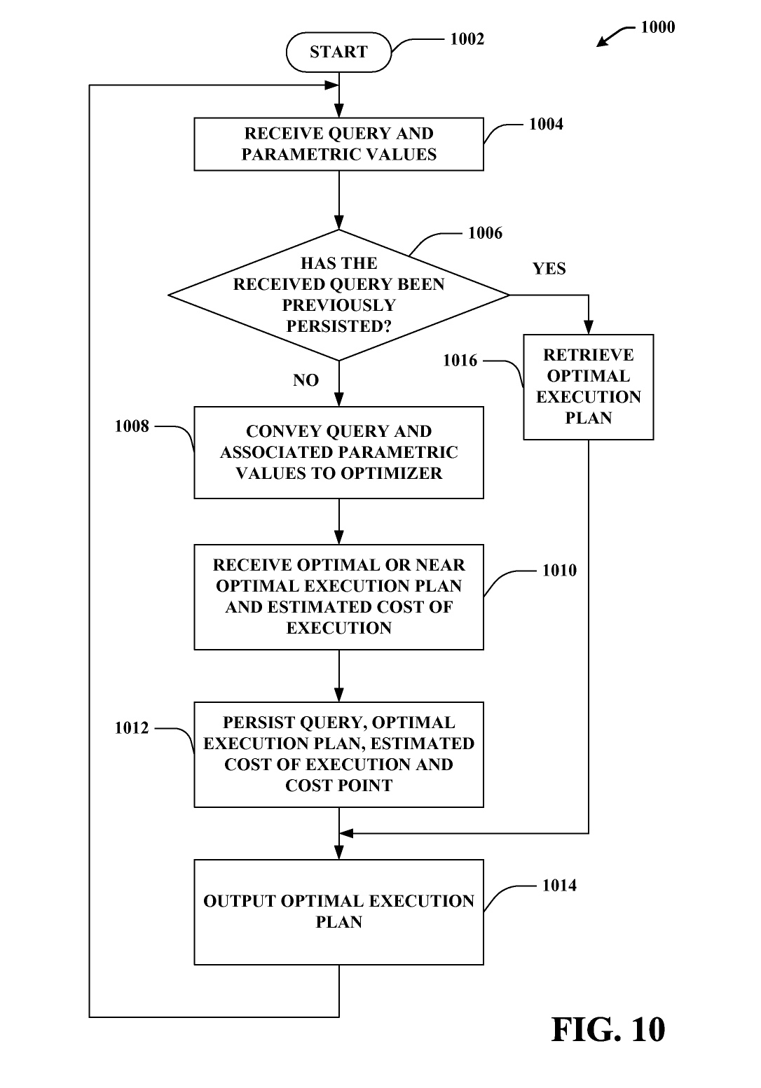

In view of the exemplary systems shown and described supra, methodologies that may be implemented in accordance with the disclosed subject matter will be better appreciated with reference to the flow chart of FIG. 10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 10 provides a flow diagram of a methodology 1000 that facilitates and effectuates progressive parametric query optimization in accordance with one aspect of the claimed subject matter. Method 1000 commences at 1002 whereupon various sundry initialization tasks and background activities are performed. Upon completion of these various tasks and activities, method 1000 proceeds to 1004 where queries and associated parametric values are received. At 1006 a determination is made as to whether the query received has been previously submitted and/or registered. Where it is determined that the query has not been submitted and/or registered in the past (e.g., NO), the method proceeds to 1008 whereupon the query and associated parametric values are conveyed to an optimization means that determines the most optimal and/or nearly optimal execution plan that can be employed to evaluated the query and returns the execution plan together with an estimated execution cost associated with the execution plan. At 1010 the methodology receives the optimal and/or near optimal execution plan and the associated estimated cost of execution, and proceeds to 1012 where the methodology persists the query, optimal and/or near optimal execution plan, estimated execution cost, and cost point to a storage means for future use in evaluating subsequently submitted queries and parametric values. At 1014 the method outputs the optimal and/or nearly optimal execution plan for subsequent utilization in the evaluation of the query and its associated parametric values. Alternatively, at 1006 where it is ascertained that identical and/or similar queries have been submitted, optimized, and registered in the past (e.g., YES) the method proceeds to 1016 where an optimal or near optimal execution plan is selected and acquired, at which point the method progresses to 1014 where the method output the selected execution plan for utilization in the evaluation of the submitted query and its associated parametric values.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

The benefit of object technology arises out of three basic principles: encapsulation, polymorphism and inheritance. Objects hide or encapsulate the internal structure of their data and the algorithms by which their functions work. Instead of exposing these implementation details, objects present interfaces that represent their abstractions cleanly with no extraneous information. Polymorphism takes encapsulation one-step further—the idea being many shapes, one interface. A software component can make a request of another component without knowing exactly what that component is. The component that receives the request interprets it and figures out according to its variables and data how to execute the request. The third principle is inheritance, which allows developers to reuse pre-existing design and code. This capability allows developers to avoid creating software from scratch. Rather, through inheritance, developers derive subclasses that inherit behaviors that the developer then customizes to meet particular needs.

In particular, an object includes, and is characterized by, a set of data (e.g., attributes) and a set of operations (e.g. methods), that can operate on the data. Generally, an object's data is ideally changed only through the operation of the object's methods. Methods in an object are invoked by passing a message to the object (e.g., message passing). The message specifies a method name and an argument list. When the object receives the message, code associated with the named method is executed with the formal parameters of the method bound to the corresponding values in the argument list. Methods and message passing in OOP are analogous to procedures and procedure calls in procedure-oriented software environments.

However, while procedures operate to modify and return passed parameters, methods operate to modify the internal state of the associated objects (by modifying the data contained therein). The combination of data and methods in objects is called encapsulation. Encapsulation provides for the state of an object to only be changed by well-defined methods associated with the object. When the behavior of an object is confined to such well-defined locations and interfaces, changes (e.g., code modifications) in the object will have minimal impact on the other objects and elements in the system.

Each object is an instance of some class. A class includes a set of data attributes plus a set of allowable operations (e.g., methods) on the data attributes. As mentioned above, OOP supports inheritance—a class (called a subclass) may be derived from another class (called a base class, parent class, etc.), where the subclass inherits the data attributes and methods of the base class. The subclass may specialize the base class by adding code which overrides the data and/or methods of the base class, or which adds new data attributes and methods. Thus, inheritance represents a mechanism by which abstractions are made increasingly concrete as subclasses are created for greater levels of specialization.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

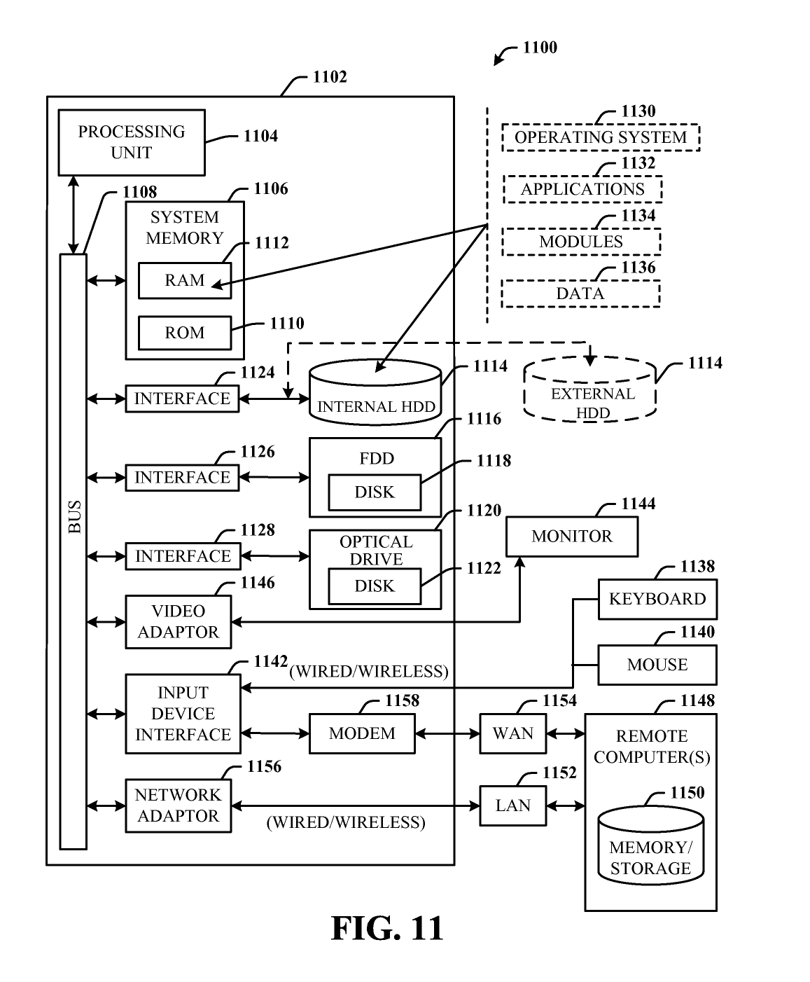

Referring now to FIG. 11, there is illustrated a block diagram of a computer operable to execute the disclosed progressive parametric query optimization system. In order to provide additional context for various aspects thereof, FIG. 11 and the following discussion are intended to provide a brief, general description of a suitable computing environment 1100 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the claimed subject matter.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the claimed subject matter can be implemented with various commercially available operating systems or combinations of operating systems.

A user can enter commands and information into the computer 1102 through one or more wired/wireless input devices, e.g. a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 11156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

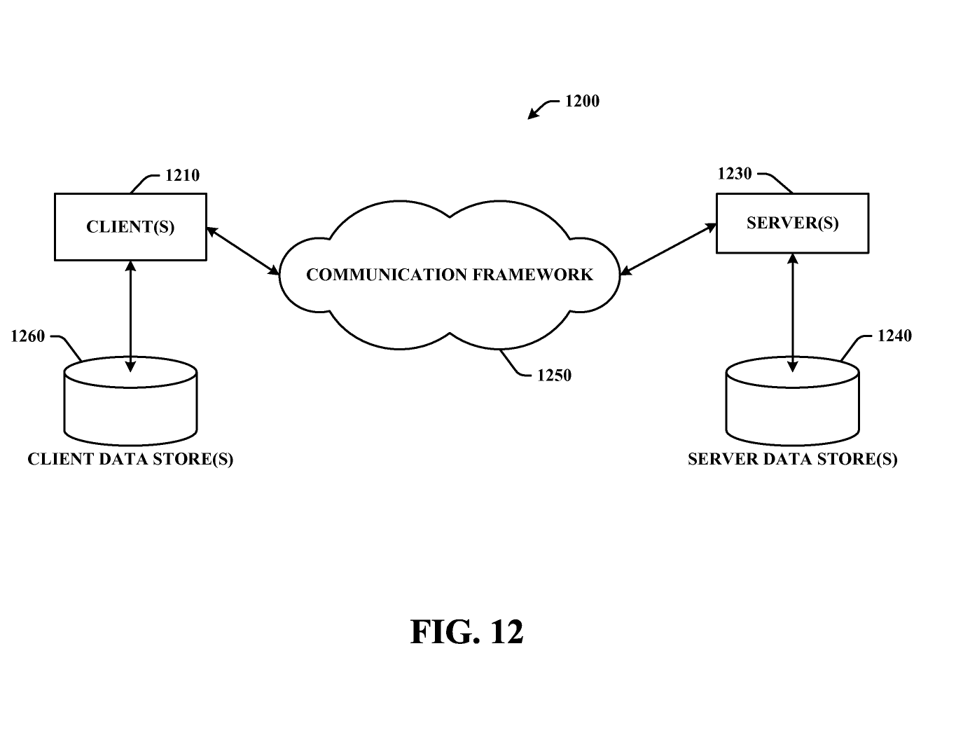

Referring now to FIG. 12, there is illustrated a schematic block diagram of an exemplary computing environment 1200 for processing the progressive parametric query optimization architecture in accordance with another aspect. The system 1200 includes one or more client(s) 1202. The client(s) 1202 can be hardware and/or software (e.g., threads, processes, computing devices). The client(s) 1202 can house cookie(s) and/or associated contextual information by employing the claimed subject matter, for example.

The system 1200 also includes one or more server(s) 1204. The server(s) 1204 can also be hardware and/or software (e.g., threads, processes, computing devices). The servers 1204 can house threads to perform transformations by employing the claimed subject matter, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that effectuates and facilitates database query optimization, comprising:
a progressive optimization component that receives a query and associated parametric values, based at least in part on the query the progressive optimization component determines whether the query has been previously received, and based at least on the determination the progressive optimization component generates from previously received queries an optimal or near-optimal execution plan utilized to evaluate the query and associated parametric values.

2. The system of claim 1, based at least in part on the determination the progressive optimization component conveys the query to a database optimizer.

3. The system of claim 2, the database optimizer, based at least on the query generates the optimal execution plan and associates an estimated execution cost with the optimal or near-optimal execution plan.

4. The system of claim 1, the previously received queries persisted in a data store associated with the progressive optimization component.

5. The system of claim 4, the progressive optimization component consults the data store to determine whether the query has been previously received.

6. The system of claim 1, the progressive optimization component intercepts the query and associated parametric values before the query and associated parametric values can be conveyed to a database optimizer.

7. The system of claim 6, the progressive optimization component intercepts and persists an output from the database optimizer.

8. The system of claim 7, the output includes one of the optimal or near-optimal execution plan or an estimated cost associated with executing the optimal execution plan.

9. The system of claim 1, the progressive optimization component employs a technique that generates the optimal or near-optimal execution plan based on a bounded cost specified by a user.

10. The system of claim 1, the progressive optimization component utilizes a technique that minimizes the number of optimization calls made to a database optimizer.

11. A method implemented on a machine that effectuates database query optimization, comprising:
receiving a query and associated values;
determining whether the query has previously been received;
based at least in part on the query, obtaining an optimal execution plan and an expected cost associated with execution of the optimal execution plan; and
utilizing the optimal execution plan to evaluate the query and associated values.

12. The method of claim 11, based at least in part on the obtaining, persisting at least one of the query, the optimal execution plan, or the expected cost associated with execution of the optimal execution plan to preclude future obtaining of the optimal execution plan for a similar query and similar accompanying values.

13. The method of claim 11, based at least in part on the determining, transmitting the query to an optimizer associated with a database management system.

14. The method of claim 13, the optimizer, based on at least on the query, providing the optimal execution plan and the associated expected cost to execute the query and associated values.

15. The method of claim 11, further comprising utilizing a technique that generates the optimal execution plan based at least in part on a bounded cost specified by a user.

16. The method of claim 11, further comprising employing a modality that minimizes optimization calls to an optimizer associated with a database management system.

17. A system that effectuates database query optimization, comprising:
means for accepting one or more parametric queries;
means for determining whether the one or more parametric queries have previously been accepted; and
means for locating an optimal execution plan based on the results from the means for determining.

18. The system of claim 17, the means for locating includes a means for persisting that stores the optimal execution plan based on the one or more parametric queries and an estimated cost associated with executing the optimal execution plan for the one or more parametric queries.

19. The system of claim 17, the means for locating includes employing a means for optimizing that returns at least the optimal execution plan and an estimated cost associated with executing the optimal execution plan for the one or more parametric queries.

20. The system of claim 19, the means for locating, based at least in part on the results from the means for determining, obviates utilization of the means for optimizing when the one or more parametric queries have previously been accepted.
